(19) United States
(12) Patent Application Publication
(10) Pub. No.: US 2004/0137983 A1
(43) Pub. Date: Jul. 15, 2004

(54) Gaming accessory for wireless devices

(75) Inventors: John Sexton Kerr, Chicago, IL (US); John R. Fitzsimons JR., Wheeling, IL (US); William R. Rochowicz, Park Ridge, IL (US)

Correspondence Address: MOTOROLA INC, 600 NORTH US HIGHWAY 45, ROOM AS437, LIBERTYVILLE, IL, 60048-5343, US

(73) Assignee: GAMING ACCESSORY FOR WIRELESS DEVICES

(21) Appl. No.: 10/342,072

(22) Filed: Jan. 13, 2003

(51) Int. Cl. A63F 13/02

(52) U.S. Cl. 463/29

(57) ABSTRACT

The present invention provides an apparatus that allows a user to easily perform a gaming operation while playing a game on a handheld wireless device without weakening the battery in the phone. This apparatus allows a user to effortlessly perform a gaming operation on the handheld wireless device while simultaneously charging the phone and implementing a vibration mechanism on the apparatus. In addition, this apparatus provides the advantage of allowing a user to play a game for a prolonged period of time without depleting the battery power of the wireless phone.

### BACKGROUND

The present invention relates generally to wireless devices. More particularly, the present invention relates to a method and apparatus for enhancing a wireless gaming experience on a wireless device.

Consumers throughout the world use wireless phones or handheld wireless devices for business and personal purposes. Handheld wireless devices refers to: mobile phones, pagers, radios, personal digital assistants (PDAs), notebook or laptop computers incorporating wireless modems, mobile data terminals, application specific gaming devices, video gaming devices incorporating wireless modems, etc. Usually, people use these wireless phones to communicate verbally or electronically. However, wireless phones may also be used as a personal digital assistant, an appointment book, a phone book, an alarm and as a gaming device (wireless or standalone).

Software programs included in wireless phones enable the wireless phones to function as a wireless gaming device. Some of the previous software programs were for primitive computer games. For example, Tic Tac Toe or Solitaire, which require only a very basic user interface.

Over time, new software tools were developed for wireless phones. These software tools combined with improved graphics and display technology allow today's game designers to deliver high resolution, multicolor images that improve the gaming experience on wireless phones. Even though the new advances have improved the wireless phone as a gaming platform, there are several problems with playing a game or performing a gaming operation on a wireless phone.

Since many wireless device's primary function are not solely gaming their user interface and shape may not be optimized for gaming. The ergonomic design of a wireless device is usually organized around its primary function as phone, organizer, etc. This design can make the device uncomfortable to use or hold for long periods while playing games. For example, it may be desirable to have an extremely thin PDA, allowing easy portability. However, thin devices can be awkward to hold with both hands in a ‘landscape’ orientation common to game playing. As another example, a person performing a gaming operation on a wireless device must simultaneously hold the device and press multiple buttons rapidly which can be cumbersome and unpleasant. The buttons on such a device are often small and either in close proximity to each other or too far apart from each other. Either case can make it difficult to operate the buttons in rapid succession.

Additionally, when a person is playing a game on a wireless phone, the battery of the wireless device will be depleted quickly.

Accordingly, there is a need for an apparatus that allows a user to comfortably and easily perform a gaming operation on a wireless device while supplementing power to the battery.

### BRIEF DESCRIPTION OF SEVERAL VIEWS OF THE DRAWINGS

FIG. 1 is a schematic diagram showing a prior art wireless phone;

FIG. 2 is an illustrated block diagram of the wireless phone of FIG. 1;

FIG. 3 is an external view of a first embodiment of a gaming shell structure;

FIG. 4 is a detailed circuit diagram of the first embodiment of the gaming

shell structure of FIG. 3;

FIG. 5 is a detailed circuit diagram of the first embodiment of the gaming shell structure of FIG. 3 including optional components;

FIG. 6 is a schematic diagram showing the wireless phone in a recessed portion of a first embodiment of the gaming shell structure of FIG. 3;

FIG. 7 is an external view of a second embodiment of a gaming shell structure;

FIG. 8 is a detailed circuit diagram of the second embodiment of the gaming shell structure of FIG. 7;

FIG. 9 is a schematic diagram showing the wireless phone connected to the second embodiment of the gaming shell structure of FIG. 7;

FIG. 10 is a flow chart that depicts the interaction between the wireless phone and the first embodiment of the gaming shell structure of FIG. 4; and

FIG. 11 is a flow chart that depicts the interaction between the wireless phone and the first embodiment of the gaming shell structure including the optional components of FIG. 5;

FIG. 12 is a flow chart that depicts the interaction between the wireless phone and the second embodiment of the gaming shell structure of FIG. 7.

### DETAILED DESCRIPTION OF THE PRESENTLY PREFERRED EMBODIMENTS

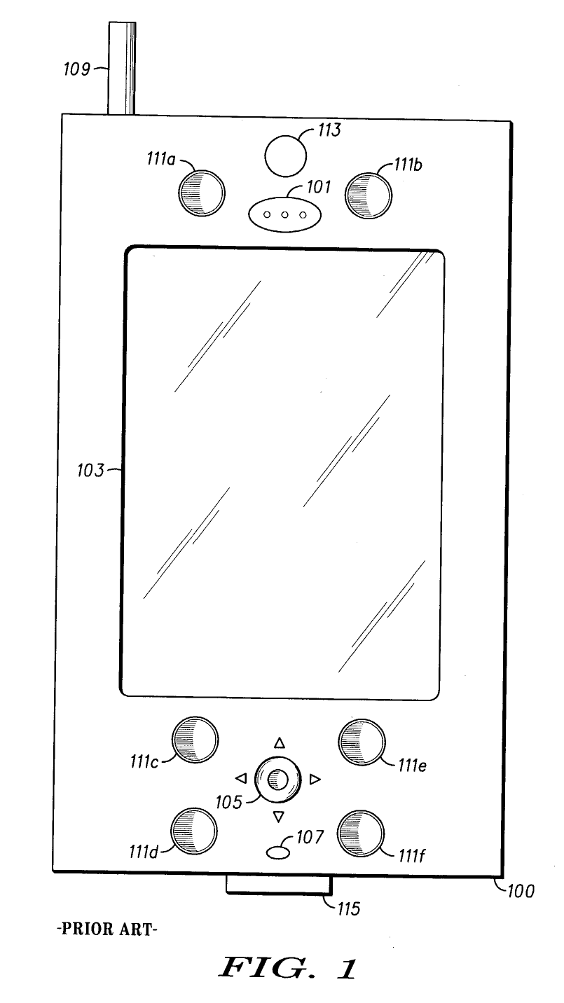

FIG. 1is a schematic diagram of a prior art wireless phone 100. The conventional wireless phone may also be referred to as a handheld wireless device. Handheld wireless devices include: cellular phones, mobile phones, pagers, radios, personal digital assistants (PDAs), mobile data terminals, application specific gaming devices, video gaming devices incorporating wireless modems, etc. Wireless phone 100 may also incorporate any one of the handheld wireless devices, for example the wireless phone 100 can include a PDA. Since the operation of a conventional wireless phone is well known a description of the operation of the wireless phone 100 has been omitted.

This wireless phone 100 includes the following components: a speaker 101, a display 103, a plurality of starpad buttons 105, a microphone 107, an antenna 109, gaming buttons 111a-f, an integrated camera 113 and an accessory port 115 connected together in any suitable combination. Wireless phone 100 also includes an on-off switch (not shown) for completely powering down or turning off the wireless phone. Each component of wireless phone 100 will be described.

Speaker 101 is equivalent to any type of conventional speaker used for a mobile phone or cellular phone. Next to speaker 101 on the wireless phone 100 is the display 103. Display 103 is equivalent to any conventional display device used for a cellular phone or mobile phone, such as a liquid crystal display. Below the display 103 there is a plurality of starpad buttons 115. The plurality of starpad buttons 105 is utilized by at least one user to input information into the wireless phone 100. The plurality of starpad buttons 105 are equivalent to an input device, such as a keyboard, mouse, touch screen, graphical user interface or any other device or method that can be utilized as an input device. In an alternative embodiment, the plurality of starpad buttons 105 are utilized with display 103 to provide an enhanced user interface on the wireless phone 100. Below plurality of starpad buttons 115 is microphone 107.

Microphone 107 is equivalent to a conventional microphone used in a wireless phone. Antenna 109 is equivalent to the conventional antenna used for a wireless phone, antenna 109 includes an external antenna connection which when used with an external antenna bypasses the existing antenna 109 to enhance signal strength. Below antenna 109 are gaming buttons 111a-f. Gaming buttons 111a-f are equivalent to conventional gaming buttons used in wireless phones. Gaming buttons 111a-f interfaces with the integrated camera 113. Integrated camera 113 is equivalent to a conventional integrated camera used in a wireless phone. Alternatively, the integrated camera 113 may include a two-way camera. The camera is connected to a controller 211 of the wireless phone 100, which is connected to the accessory port 115, and could potentially be used to send image data across the accessory port 115.

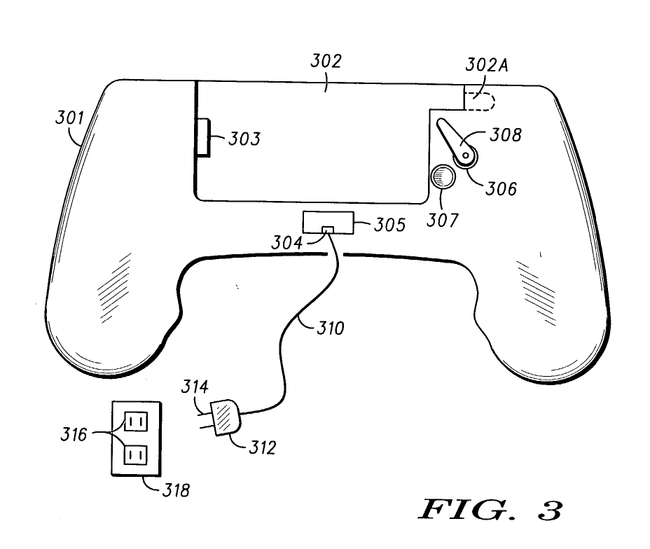

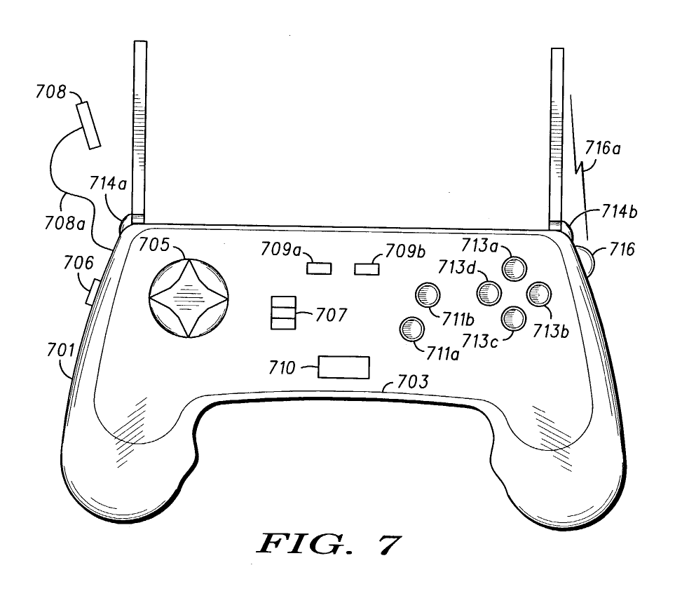

The accessory port 115 is a connection port for receiving and transmitting information from an external device such as a computer or the accessory port of a first embodiment of gaming shell structure 301 or second embodiment of gaming shell structure 701 of FIGS. 3 and 7, respectively. Accessory port 115 may also serve as the connection port for a standard battery charging device. Accessory port 115 is in communication with interface device 204 of wireless phone 100. This interface device 204 receives and transmits information from the controller 211 in the wireless phone 100 through the accessory port 115 to the accessory ports of gaming shell structure 301 (FIG. 3) or gaming shell structure 701 (FIG. 7).

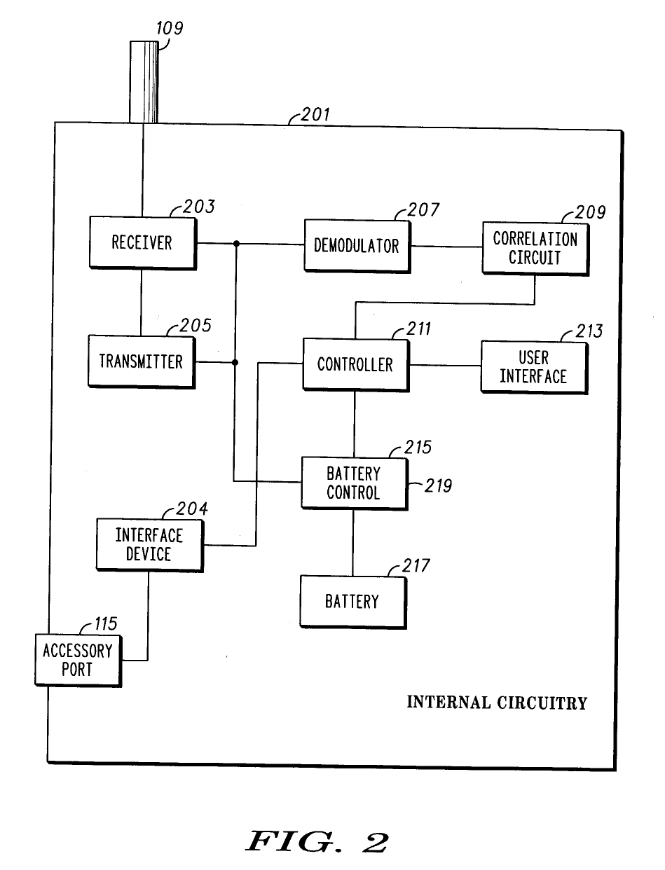

FIG. 2 is a block diagram of the wireless phone of FIG. 1. Wireless phone 100 includes a typical internal electrical circuitry 201 found in wireless phones, for example the antenna 109, a tunable receiver 203, an interface device 204, a transmitter 205, a demodulator 207, a correlation circuit 209, a controller 211, a user interface 213, a battery 217, a battery control 215 and a control input 219. Generally, the electrical circuitry 201 works in cooperation with the speaker 101, display 103, plurality of starpad buttons 105, microphone 107, gaming buttons 111a-f, integrated camera 113 and accessory port 115.

Turning to the operation of the wireless phone 100. Wireless phone 100 may receive and transmit information by utilizing the antenna 109 and/or the interface device 204 then both components transfer the information to the controller 211.

Upon reception of radio frequency (RF) signals, the wireless phone 100 receives the RF signals through the antenna 109. The antenna 109 detects the received RF signals. The tunable receiver 203 is coupled through a port (not shown) to the path of the antenna 109 and converts the RF signals into baseband signals. The channel or frequency at which the tunable receiver 203 receives signals is controlled by the controller 211. The demodulator 207 is also coupled to the receiver 203. The demodulator 207 demodulates the baseband signals, and provides the data to the correlation circuit 209. The correlation circuit 209 correlates the digital data and recovers the data transmitted on the RF signals. The correlation circuit 209 provides the recovered data to the controller 211.

Turning to the operation of the interface device 204, this interface device is the internal mechanism controlling the accessory port 115, which allows wireless phone 100 to receive and transmit information to gaming shell structure 301 (FIG. 3) or gaming shell structure 701 (FIG. 7). For example, when the interface device 204 receives data and/or serial signals from the accessory port 115, then it transmits the data to controller 211. The controller 211, in turn, transmits the appropriate response to the interface device 204. Then interface device 204 transmits the response to the gaming shell structures 301 and 701. The interface 204 device may have several different forms.

In one embodiment, the interface device 204 is a software algorithm that is compatible with an interface device of first and second embodiments of the gaming shell structure 301 and 701. For example, the interface device 204 is an application program interface (API) program compatible with the interface device of gaming shell structures 301 and 701. Alternatively, the interface device 204 is a hardware device having pre-processing functionality that is compatible with the interface device of gaming shell structures 301 and 701. For example, the interface device 204 is a network interface, optical sensor interface, modem, or Ethernet interface that is compatible with the interface device of gaming shell structures 301 and 701.

In another embodiment, the interface device 204 of wireless phone 100 may be implemented as a combination of software and hardware that is compatible with the interface device of gaming structures 301 and 701. Further, the interface device 204 may include software functionality to decode, decrypt, authenticate or otherwise implement secure communications with gaming shell structures 301 and 701.

In an alternative embodiment, interface device 204 includes one or more of a Universal Serial Bus (USB) transceiver, an RS-232 Transceiver, IrDA, Bluetooth, manufacturer specific or other similar communications protocols. In order to understand the aforementioned different types of interface devices available the terms IrDA, Bluetooth, USB and RS-232 will be described.

Infrared Data Association (IrDA) is a standard form of wireless transmission, which is a focused ray of light in the infrared frequency spectrum that is modulated with information sent from a transmitter to a receiver over a short distance.

Bluetooth is a computing and telecommunications industry specification that describes how mobile phones, computers, and personal digital assistants (PDAs) can easily interconnect with each other and with home and business phones using a short-range wireless RF connection. USB is a standard interface between a computer and add-on devices, for example joysticks, keyboards, etc. RS-232 is a standard data interface protocol used in PC's and other devices which allow them to communicate and exchange data with modems and other serial devices.

With regard to the operation of controller 211, when the controller 211 receives the data from the correlation circuit 209 and/or interface device 204 the controller 211 processes this data in various ways. In the first case, when the controller 211 receives data from the correlation circuit 209, the controller 211 formats the data into recognizable voice or information for use by user interface 213. The user interface 213 communicates the received information or voice to a user. User interface 213 includes the components of wireless phone 100, for example speaker 101, plurality of starpad buttons 105, microphone 107, gaming buttons 111a-f and the integrated camera 113.

In the next case, when the controller 211 receives information from the interface device 204. The controller 211, in turn, transmits the appropriate response to the interface device 204. Interface device 204 receives the response, then transmits it through accessory port 115 to gaming shell structures 301 and 701.

While the interface device 204 may have different configurations, the controller 211 may also have different configurations. In one embodiment, the controller 211 or any portion in the electrical circuitry of wireless phone 100 can include software program applications. The software program applications include: Microsoft Word®, Microsoft Excel®, Microsoft Powerpoint®, I-mode, Java, Pocket PC, wireless application protocol (WAP), Linux, Symbian and Binary Runtime Environment for Wireless (BREW). Microsoft Word®, Microsoft Excel®, Microsoft Powerpoint® are all registered trademarks of Microsoft Corporation having a corporate headquarters in Redmond, Wash. The controller may also include software application specific to gaming similar to Chess, Doom, Pac-Man, or Defender. Software program applications are written using programming languages specifically designed to create complete applications that may run on a mobile phone, a computer or be distributed among servers and clients in a network.

In an alternative embodiment, the controller 211 or any portion of wireless phone 100 can include a personal digital assistant, a web browser, a contact list, a calendar, task list, an MP3 player, a global positioning system (GPS), an advanced email and messaging system, a document/edit viewer system, application specific gaming devices, video gaming devices incorporating wireless modems and software applications in any portion of the wireless phone 100.

Alternatively, the controller 211 may be implemented as hardware. Preferably, this hardware includes microprocessors, micro-controllers, or digital signal processors, having an electronic erasable program read only memory (EEPROM) or Flash memory, static random access memory (RAM), a clocking/timing circuit, or any typical processor utilized in an electrical device.

Controller 211 is connected through the battery control 215 to the battery 217. Battery 217 provides the power for wireless phone 100. The battery 217 is preferably, a removable, rechargeable battery, such as nickel-metal-hydride battery, a lithium ion battery, power cell or other similar energy storage device. Preferably the battery 217 is designed to be physically small and lightweight while storing substantial useable energy to provide a maximum operating time for the wireless phone 100 before requiring recharge. Further, the battery 217 is preferably designed to be located in a module or other housing which is detachably joined with the other elements of the wireless phone 100 in a single handheld unit to provide a radiotelephone handset or other device which maximizes user convenience.

The battery control 215 operates as a switch for decoupling the battery 217 from predetermined portions of the wireless phone 100. As is illustrated in FIG. 2, the battery control 215 is coupled to the transmitter 205 and the receiver 203 for selectively removing battery power from the transmitter 205 and the receiver 203. The battery control 215 may also be coupled to other portions of the wireless phone 100. The battery control 215 has a control input 219 coupled to the controller 211. In response to a control signal received at the control input 219, the battery control 215 removes or applies battery power to portions of the wireless phone 100. The battery control 215 may be implemented by a switch or by any other suitable device. The battery control 215 also controls the charging of the battery. Alternatively the battery control may comprise a plurality of individual switches for decoupling circuit portions from the battery 217, each switch is individually controllable by the controller 211. Additionally the battery control 215 may comprise a switch to provide battery power to the accessory port 115 to power an external accessory. Some individual connections among the elements of the wireless station are omitted in FIG. 2 so as to not unduly complicate the figure.

FIG. 3 is an external view of a first embodiment of a gaming shell structure 301. Gaming shell structure 301 is used to receive a handheld wireless device, for example a wireless phone 100 to charge the wireless phone and/or play a game on the wireless phone 100. Gaming shell structure 301 is able to expand and collapse to fit around the back, sides and top front of wireless phone 100. This gaming shell structure 301 may be referred to as a communication device.

A shape of the gaming shell structure 301 or an outside area or outside structure can be grasped by either hands or one hand of a user to ergonomically enhance the device, increasing the comfort level for playing a game on wireless phone 100, thus allowing the user to play for an extended period of time. Gaming shell structure 301 may be made from any material, such as plastic or metal or any other material conventionally used to construct or make a controller for a video gaming system.

Gaming shell structure 301 includes an accessory port 303, an external power port 305, button 306, button 307 and lever 308. The accessory port 303 is connected to the external power port 305, button 306, button 307 and lever 308.

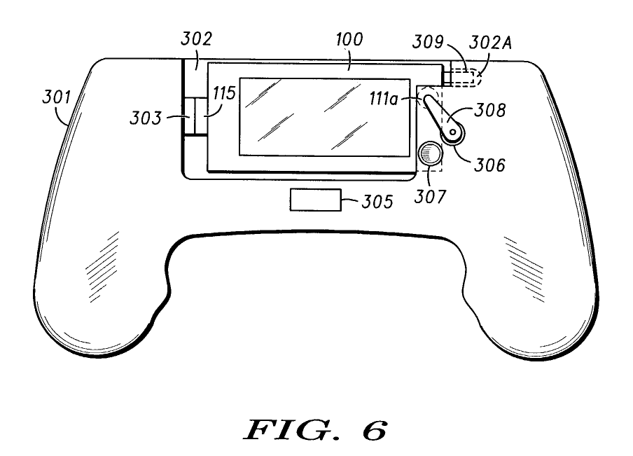

Accessory port 303 is a connection port or standard accessory connector for receiving and transmitting information (interfacing) from wireless phone 100 via the accessory port 115. This accessory port 303 is in a recess 302 in the middle portion of the gaming shell structure 301. The recess 302 is utilized to receive wireless phone 100. When the wireless phone 100 is received, then the accessory port 303 provides a connection to the accessory port 115 of wireless phone 100 shown in FIG. 6.

The recess 302 receives wireless phone 100 without damaging antenna 109 or any component on or in wireless phone 100. In addition, recess 302 includes an antenna area 302a that wraps around an antenna, for example antenna 109 of wireless phone 100. This antenna area 302a is non-metallic to avoid interfering with the operation of antenna 109. This antenna area 302a also protects the antenna 109 from being damaged. In an alternative embodiment, the recess 302 is able to receive any type of wireless phone or handheld wireless device. While the recess 302 is in the middle portion of wireless phone 100 the external power port 305 is located at a bottom middle portion of gaming shell structure 301.

This external power port 305 is a connection port or a jack for receiving power from a power supply. This port is used to charge the gaming shell's on board batteries 407. Typically, for the wire connection the external port 305 receives a plug 304 at one end of an electric cord 310. At the other end of the electric cord 310 there is a transformer 312 with transformer circuitry. The transformer 312 is connected to a plug 314 that is inserted into an electrical outlet 316 of a power supply 318. Conventionally, the transformer 312 converts an alternating current (AC) voltage from a main power supply 318 to a direct current (DC) to operate the gaming structure 301. While the external power port 305 is located at the bottom middle portion of the gaming shell structure 301 the buttons 306 and 307 are at a top right portion of the gaming shell structure 301.

The buttons 306 and 307 provide a person utilizing the gaming shell structure 301 the ability to play a game on the wireless phone 100. These buttons 306 and 307 are of a sufficient length to mechanically press through holes (not shown) in gaming structure 301 to contact and press down on the gaming buttons 111a-b (FIG. 1) to play a game or perform a gaming operation on wireless phone 100. Below buttons 306 and 307 there is a lever 308. Lever 308 is utilized to release and keep buttons 306 and 307 mechanically pressed down on gaming buttons 111a-b. Alternatively, gaming shell structure 301 includes a plurality of buttons that mechanically presses down through holes in gaming shell structure 301 to contact gaming buttons 111c-f.

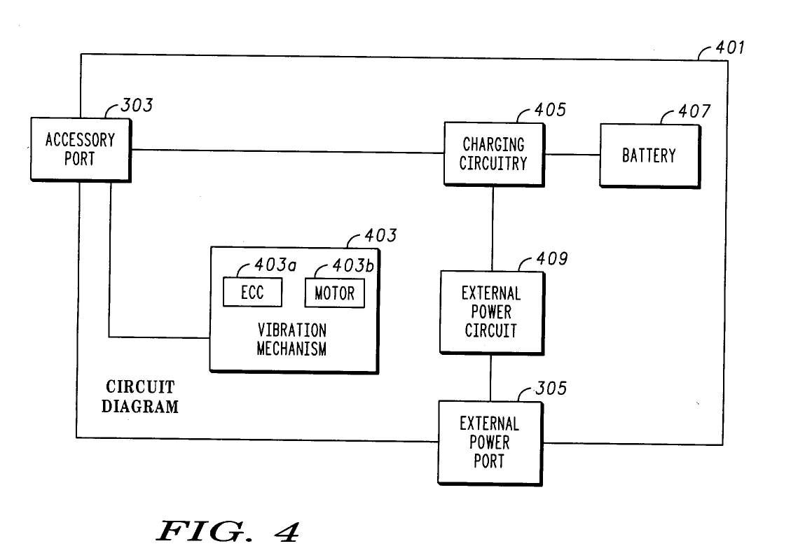

FIG. 4 is a detailed circuit diagram 401 of an operating circuitry of gaming shell structure 301. Circuit diagram 401 utilizes pre-existing software in wireless phone 100 requiring no phone hardware or software changes. This utilization of pre-existing software is important because the circuit diagram can be adapted to multiple styles/manufacturers phones. The circuitry diagram 401 duplicates the wireless phone 100 standard charger, connected at accessory port 115, thus extending game play/charging the battery 217. Essentially, the gaming structure 301 is enabled to cause the wireless phone 100 to believe it is only a charger so the gaming structure 301 can charge the wireless phone 100. The phone can also initiate a vibration motion on vibration mechanism 403 by using the pre-existing software and applying switched external power on wireless phone 100 via accessory ports 115 and 303.

Circuit diagram 401 includes: the accessory port 303, vibration mechanism 403, a charging circuitry 405, at least one battery 407, an external power circuit 409 and the external power port 305.

Accessory port 303 is coupled with the charging circuitry 405 and vibration mechanism 403. Charging circuitry 405 is further coupled with the battery 407 and the external power circuit 409. External power circuit is further coupled with the external power port 305. Vibration mechanism 403 also includes an eccentric member 403a and motor 403b. In an alternative embodiment, the components in circuit diagram 401 may be connected to each other in any suitable combination.

Turning to the operation of the accessory port 303, this device connects gaming shell structure 301 to the accessory port 115. Also, accessory port 303 continuously makes power available to wireless phone 100 and allows wireless phone 100 to control and operate vibration mechanism 403.

Wireless phone 100 enables external power to be transmitted from the battery 217 and battery control 215 through accessory port 115 to accessory port 303. Accessory port 303 directly connected to the vibration mechanism 403 transfers the power to the motor 403b. Motor 403b is energized by the power, then motor 403b transmits the power to eccentric member 403a, which makes eccentric member 403a move vibration mechanism 403 in a vibration manner.

Charging circuitry 405 is a typical charging circuitry that receives instructions to charge a battery in the wireless phone 100 or initiate vibration mechanism 403 from accessory port 303. Accessory port 303 is directly connected to charging circuitry 405, where accessory port 115 transmits a request to accessory port 303 to receive power. Charging circuitry 405 upon receiving the request obtains the power from battery 407 and/or external power circuit 409. The charging circuitry 405 transmits the power through accessory port 303 to the accessory port 115 of wireless phone 100.

For charging the wireless phone 100, charging circuitry 405 is coupled to electrical contacts (not shown) of the battery 407 and the external power circuit 409. The battery 407 is preferably, a removable, rechargeable battery, such as nickel-metal-hydride battery, a lithium ion battery, power cell or other similar energy storage device. Preferably the battery 407 is designed to be physically small and lightweight while storing substantial useable energy to provide a maximum operating time for the gaming shell structure 301 before requiring recharge. Turning to the external power circuit 409, this power circuit interfaces with the external power port 305 to receive power from an external source or main power supply as described above.

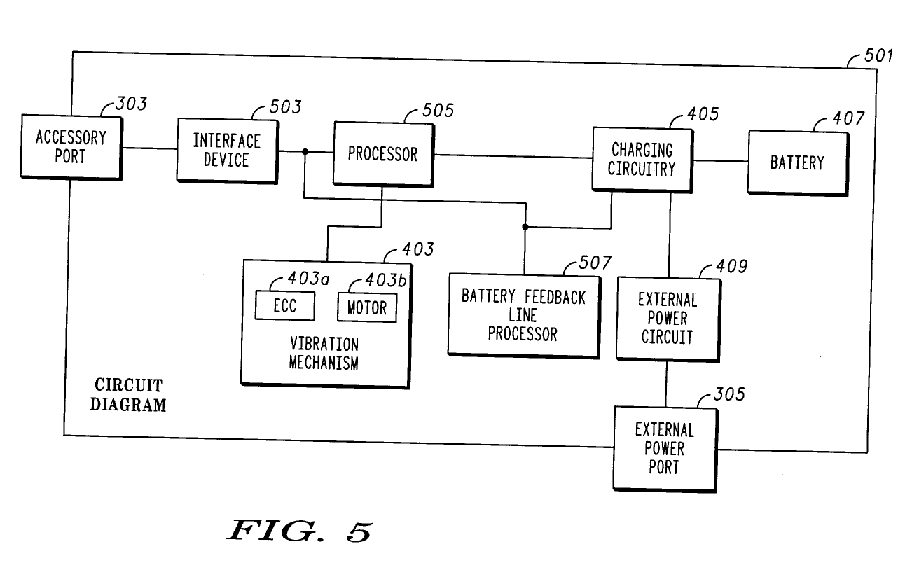

FIG. 5 is a detailed circuit diagram 501 of an operating circuitry of gaming shell structure 301 including optional components. Circuit diagram 501 enables the structure 301 to control the wireless phone 100. Circuit diagram 501 includes: the accessory port 303, an optional interface device 503, the vibration mechanism 403, an optional processor 505, a charging circuitry 405, at least one battery 407, an external power circuit 409, an optional battery feedback line processor 507 and the external power port 305. The required components the accessory port 303, vibration mechanism 403, eccentric member 403a, motor 403b, charging circuitry 405, battery 507, external power circuit 409 and the external power port 305 were described above so a description of these components is omitted.

The optional interface device 503 is coupled with the optional processor 505 and the optional battery feedback line processor 507. Optional battery feedback line processor 507 is further coupled with the charging circuitry 405. Processor 505 is further coupled with the vibration mechanism 403 and charging circuitry 405. Charging circuitry 405 is further coupled with the battery 407 and the external power circuit 221. Vibration mechanism 403 also includes an eccentric member 403a and motor 403b. In an alternative embodiment, the components in circuit diagram 501 may be connected to each other in any suitable combination.

Optional interface device 503 is the internal mechanism that receives and transmits information or instructions from the accessory port 303 to accessory port 115 to the interface device 204 of wireless phone 100. The information may be instructions to supply power to wireless phone 100 and/or initiate vibration mechanism 403 while simultaneously allowing a user to performing a gaming operation on wireless phone 100 by using buttons 306 and 307. When interface device 503 receives the instructions as data and/or serial signals from accessory port 115, then the interface device 503 transmits the data to the processor 505.

Turning to the operation of interface device 503, this device allows gaming shell structure 301 to detect when the accessory port 115 is connected to accessory port 303. Also, interface device 503 continuously makes power available to wireless phone 100 and allows wireless phone 100 control vibration mechanism 403.

In one embodiment, the interface device 503 further generates an acknowledgement communication to the wireless phone 100 acknowledging receipt of the information. In another embodiment, the interface device 503 is a software algorithm that is compatible with the interface device 204 of wireless phone 100. For example, the interface device 503 is an application program interface (API) program compatible with the interface device 204. Alternatively, the interface device 503 is a hardware device having pre-processing functionality that is compatible with the interface device 204. For example, the interface device 503 is a network interface, optical sensor interface, modem, or Ethernet interface that is compatible with the interface device 204 of wireless phone 100. The interface device 503 as a hardware device may also include electrical components that can receive and transmit information in a Communication Enterprise Bus (CEBus) standard.

In another embodiment, the interface device 503 may be implemented as a combination of software and hardware that is compatible with the interface device of wireless phone 100. Further, the interface device 503 may include software functionality to decode, decrypt, authenticate or otherwise implement secure communications with wireless phone 100. The interface device 503 is in turn connected processor and battery feed back line processor 507.

As stated above, processor 505 or battery feedback line processor 507 receives the instructions from interface device 503, then processor 505 or battery feedback line processor 507 acts on the instructions. In one embodiment, processor 505 or battery feedback line processor 507 is implemented in a software program. The software program in processor 505 or battery feedback line processor 507 may include an algorithm for initiating a vibration mechanism 403. Also, the software program includes an algorithm to instruct the external power circuit 409 and/or battery 407 to transmit voltage/current to the vibration mechanism 403 and charging circuitry 405.

Alternatively, the optional processor 505 or optional battery feedback line processor 507 may be implemented as hardware integrated with the hardware and/or software that form the structure 301. Preferably, this hardware includes microprocessors, micro-controllers, or digital signal processors, having an electronic erasable program read only memory (EEPROM) or Flash memory, static random access memory (RAM), a clocking/timing circuit, or any typical processor utilized in an electrical device. In another embodiment, the processor 505 or battery feedback line processor may be implemented as a combination software algorithm and hardware device. The optional processor 505 transmits instructions to the vibration mechanism 403 and charging circuitry 405.

Vibration mechanism 403 includes the motor 403b and the eccentric member 403a. When processor 505 receives instructions to initiate vibration mechanism, it transmits the instructions to charging circuitry 405 to transmit power to motor 403b to energize the motor. Motor 403b then transmits the power to eccentric member 403a, which makes eccentric member 403a move vibration mechanism 403 in a vibration manner. Vibration mechanism 403 is connected through processor 505 to charging circuitry 405. Charging circuitry 405 is a typical charging circuitry that receives instructions to charge a battery in the wireless phone 100.

FIG. 6 is a schematic diagram showing the wireless phone of FIG. 1 in a recess portion of the first gaming shell structure of FIG. 3. This diagram illustrates how the wireless phone 100 is placed in the first gaming shell structure 301. Gaming shell structure 301, as stated above, includes recess 302 and antenna area 302 that is shaped to receive the wireless phone 100 with antenna 109. In an alternative embodiment, gaming shell structure 301 includes a recess that can receive any type of wireless phone or handheld wireless device. After the wireless phone 100 is inserted in the gaming shell structure 301, then gaming shell structure 301 utilizes accessory port 303 to interface with accessory port 115 of wireless phone 100. The display 103 and gaming buttons 111c-f of wireless phone 100 are visible and accessible while the gaming buttons 111a-b are covered by the gaming shell structure 301. Gaming buttons 111a-b are covered by gaming shell structure 301 where buttons 306 and 307 mechanically contact these buttons 111a-b to control these buttons.

FIG. 7 is an external view of a second embodiment of a gaming shell structure 701. Gaming shell structure 701 is utilized to receive a handheld wireless device, for example wireless phone 100. Gaming shell structure 701 may be referred to as a communication device. The gaming shell structure 701 or outside area or outside structure has a shape that can be grasped by both hands or one hand, and has a housing have an exterior formed projecting with a plurality of buttons and other components, which when depressed, are operable to generate an electrical signal. The shape of gaming shell structure 701 ergonomically enhances time and potential for playing a game on wireless phone 100. Gaming shell structure 701 may be made from any material, such as plastic and/or metal conventionally used to construct a controller for a video gaming system. The gaming shell structure 701 also includes an operating area 703.

The operating area 703 includes: a cross-shaped digital direction switch 705, a triggering switch 706, a battery meter 707, status indicator lights 709a-709b, function buttons 711a-b, gaming buttons 713a-d, hinges 714a-b, interface connector 708a and an optional antenna 716. In the illustrated embodiment, gaming shell structure 701 also has an underside portion (not shown), a lower middle portion, an upper left portion and an upper right portion. Interface port 708a is located on a left side of the underside portion. External port 710 is at the lower middle portion. Hinges 714a-714b are at the upper left and right portions of the operating area 703 of gaming shell structure 701. Antenna 716 is located at a top right portion of gaming shell structure 701. Interface connector 708a may be a cable or a mechanical extension of gaming shell 701.

The operating area 703 is formed on an upper surface of gaming structure 701 in a planar shape running from switch 705 through gaming buttons 713a-d. The components residing on operating area 703 are connected to the electronic circuitry of gaming shell structure 701. Gaming shell structure 701 utilizes the hinges 714a-714b and the accessory port 708a, located above the operating area 703 to receive and connect with the wireless phone 100. These hinges 714a-b are able to rotate from 0 to 180° degrees in order for a user to view the display 103. Preferably, these hinges 714a-b act as rotating knuckles, which rotate between 90° and 135° degrees in order for the user to view the display 103.

In the operating area 703 of the gaming structure 701, the cross-shaped digital direction switch 705 (“switch 705”) and triggering switch 706 are located on a left portion. The battery meter 707, status indication lights 709 and the function buttons 711a-b are located on a middle portion of operating area 703. A right portion of the operating area 703 includes the gaming buttons 713a-d, which are located parallel to the switch 705.

Switch 705 is a direction switch for designating the direction of movement of a player controlled character or a cursor, which has upper, lower, left and right depression points to be used for designating movement in four directions. On the left side of switch 705 is the triggering switch 706.

Triggering switch 706 is utilized to initiate a function of gaming shell structure 701 when a mobile phone such as the wireless phone 100 of FIG. 1 with a gaming operation is interfaced with the structure 701. For example, triggering switch 706 may be used to initiate the recharging function of gaming shell structure 701 and/or initialize the utilization of switch 705, function buttons 711a-b and gaming buttons 713a-d. Gaming buttons 713a-d are parallel to accessory port 708.

Accessory port 708 uses interface connector 708a to connect through hinges 714a to accessory port 115 to allow gaming shell structure 701 the ability to interface with wireless phone 100. Interface connector 708a is any type of conventional connector utilized to interface between at least two computers or handheld wireless devices, for example a Universal Serial Bus (USB). Interface connector 708a may also be the standard accessory port of the given wireless device 100, mating to accessory port 115. The accessory port 708 serves a connection port for receiving and transmitting (interfacing) information from wireless phone 100 via the accessory port 115. Accessory port 708 is equivalent to the accessory port 303 described above so a description of accessory port 708 has been omitted.

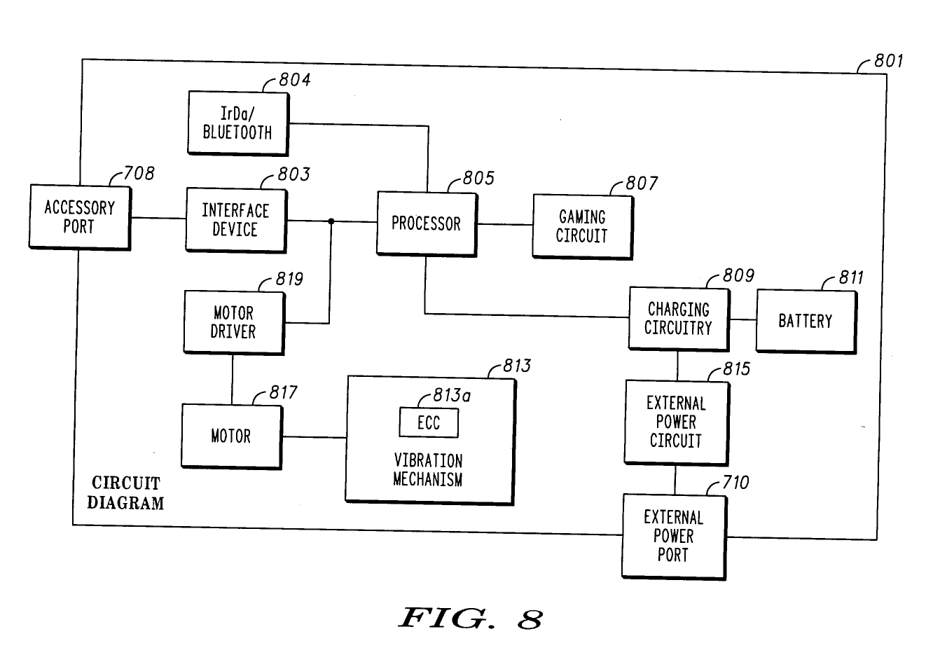

Battery meter 707 is utilized with the electrical circuitry of the gaming structure 701, described below in conjunction with FIG. 8, to indicate the amount of power being supplied to the wireless phone 100 or being utilized by wireless phone 100. In an alternative embodiment, battery meter 707 indicates the amount of power at battery 719 or at external power circuit 815. Battery meter 707 includes a plurality of light emitting diodes (LEDs) to indicate battery power. For example, if there is low battery then only one of the three LEDs may be turned ON. In another example, if there is a high battery power, then all of the LEDS may be turned ON. The LEDs may be of various colors, such as yellow, orange, purple, blue etc. Status indicator lights 709a-b similar to battery meter 707 is connected with the electrical circuitry gaming shell structure 701.

In accordance with one embodiment, these status indicator lights 709a-b are a plurality of light emitting devices, for example light emitting diodes (LEDs). The LEDs have many colors, for example red, green, blue, orange, yellow etc.

The status indicator lights 709a-b also have many different functions. First, status lights 709a-709b can be used to indicate that the gaming shell structure 701 is connected to wireless phone 100. This connection indicates that the interface device 204 through the accessory port 115 is connected to the interface device 711 via the accessory port 708. For example, status indicator light 709a may include a green light emitting diode (LED) turned ON to indicate the gaming shell structure 701 is connected to the wireless phone 100. The status indicator light 709b may include a red LED turned ON to indicate the gaming shell is not connected to gaming shell structure 701.

Second, the status lights 709a-709b are used in conjunction with the controller 211 in wireless phone 100 and electrical circuitry of gaming structure 701 to indicate a rapid-fire function. The LEDs in the status indicator lights 709a-709b alternate between ON and OFF as it receives instructions from the processor in wireless phone 100 and electrical circuitry of gaming shell structure 701.

Next, the status indicator light 709a may have a green LED turned ON to indicate that a vibration mechanism 813 is in operation. Status indicator light 709b may include a red LED turned ON to indicate that the vibration mechanism 813 is not in operation. On the right side of the status indicator lights 709a-b are function buttons 711a-b.

The function buttons 711a-711b are utilized to pause and initiate the movement of a character or cursor in a gaming operation. In relation to function buttons 711a-b, there is an external power port 710 located on a bottom middle portion of gaming shell structure 701. External power port 710 is connected to accessory port 708. This external power port 710 operates as the external power port 305 described above so a description of the external power port 710 has been omitted. In relation to the external power port 710, there gaming buttons 713a-d located on a top right portion of gaming structure 701.

Gaming buttons 713a-d, which may have various functions depending on the game software, are used, for example, to launch a missile in a shooting game, or to designate various actions such as jumping, kicking, punching, flipping in an action game.

Turning to the optional antenna 716, this antenna 716 includes an antenna connector 716a that is connected to a switch (not shown) on wireless phone 100 which detects the presence of an external antenna and selects the external antenna when present. Antenna connector 716a then connects directly to the receiver 203 to ensure a higher rate of network reliability as a result of improved antenna performance. The antenna connector 716a can be any type of conventional antenna connector used for wireless phones. This antenna 716 enables the wireless phone 100 to receive and transmit signals and improve radio frequency (RF) performance while it is connected to the gaming shell structure 701.

FIG. 8 is a detailed circuit diagram 801 of the second embodiment of the gaming shell structure 701 of FIG. 7. Circuit diagram 801 enables the structure 701 to control an operation of the wireless phone 100. Circuit diagram 801 includes: the accessory port 708, an interface device 803, IrDA/Bluetooth communication circuit 804, a processor 805, gaming keys operating circuit 807, a charging circuitry 809, at least one battery 811, a vibration mechanism 813, an external power circuit 815, a motor 817, a motor driver 819 and the external power port 710. Interface device 803 is coupled to processor 805. Processor 805 is further coupled to IrDa/Bluetooth communication circuit 804, motor driver 819, gaming key operating circuit 807 and charging circuitry 809. Charging circuitry 809 is further coupled to battery 811 and external power port circuitry 815. Motor driver 819 is further coupled to motor 817. Motor 817 is further coupled to vibration mechanism 813. Vibration mechanism 813 also includes an eccentric member 813a.

In an alternative embodiment, the components in circuit diagram 801 are connected to each other in any suitable combination. In yet another alternative embodiment, the processor 805 includes motor driver 819.

Interface device 803 is the internal mechanism that receives and transmits information through the accessory port 708 to accessory port 115 to the interface device 204. Interface device 803 is connected to status indicator lights 709a-b to indicate that there is a connection between the accessory port 115 and accessory port 708.

The information received at interface device 803 may be instructions to supply power to wireless phone 100. In addition, the information may be instructions to utilize the switch 705, function buttons 711 and/or or gaming buttons 713a-d in accordance to controlling an operation of wireless phone 100. Further, the information may be instructions to initiate vibration mechanism 813 while operating wireless phone 100. When interface device 803 receives information, such as data and/or serial signals from accessory port 115, then the interface device 803 transmits the data to the processor 805.

In one embodiment, the interface device 803 further generates an acknowledgement communication to the wireless phone 100 acknowledging receipt of the information. In another embodiment, the interface device 803 is a software algorithm that is compatible with the interface device 204 of wireless phone 100. For example, the interface device 803 is an application program interface (API) program compatible with the interface device 204 of wireless phone 100.

Alternatively, the interface device 803 is a hardware device having pre-processing functionality that is compatible with the interface device 204. For example, the interface device 803 may include a transceiver, Universal Serial Bus (USB), RS-232 Transceiver, Universal Asynchronous Receiver/Transmitter (UART), microchip or other electrical circuitry that enables it to receive and transmit information such as infrared data, Communication Enterprise (CE) Bus standard, etc. Next to interface device 803, is the IrDa, Bluetooth communication circuit 804 this circuit is not connected to a gaming pad of the wireless phone 100, which could potentially indicate loss of the wireless phone 100 charging feature, but allow free movement. In this scenario, the vibration mechanism 813 may be controlled on the circuit 801, or still by the wireless phone described in FIG. 4. When interface device 803 receives data and/or serial signals from accessory port 115 of wireless phone 100, then the interface device transmits the data to the processor 805.

Processor 805 receives the instructions from interface device 803 and acts on the instructions. In one embodiment, processor 805 is implemented in a software program. The software program in processor 805 may include an algorithm for initiating a vibration mechanism 813. In addition, the software program may include an algorithm to instruct the external power circuit 815 to transmit voltage/current to the vibration mechanism 813 and charging circuitry 809. Further, the software program may be an algorithm that allows switch 705 and gaming buttons 711a-f to function in connection with an operation of the wireless phone 100.

Alternatively, the processor 805 may be implemented as hardware. Preferably, this hardware includes microprocessors, micro-controllers, or digital signal processors, having an electronic erasable program read only memory (EEPROM) or Flash memory, static random access memory (RAM), a clocking/timing circuit, or any typical processor utilized in an electrical device. In another embodiment, the processor 805 may be implemented as a combination software algorithm and hardware device. Processor 805 processes the information or data, then transmits instructions to gaming key operating circuit 807, charging circuitry 809 and motor driver 819.

Gaming keys operating circuit 807 receives the information from processor 805 then gaming keys operating circuit 807 analyzes the gaming operation of the wireless phone 100 to determine any information associated with the gaming operation. The gaming keys operating circuit 807 is self-contained in the circuit diagram 801. The gaming key operating circuit 807 is connected to the switch 705, status indicator lights 709a-b, function buttons 711a-b and gaming buttons 713a-b. Gaming keys operating circuit 807 detects the operating states containing data of the switch 705, function buttons 711a and gaming buttons 713a-d and transfers the data through processor 805, interface device 803 to wireless phone 100. The wireless phone 100 receives the data, then performs an action on the gaming operation in response to the data. Charging circuitry 809 similar to gaming key operating circuit 807 receives instructions from processor 805.

Charging circuitry 809 is a typical charging circuitry that receives instructions to charge a battery in the wireless phone 100 from processor 805. Charging circuitry 809 is connected to battery meter 707 and status indicator lights 709a-b. The connection between charging circuitry 809 and battery meter 707 indicates the amount of power being supplied to wireless phone 100. The connection between the processor 805 and status indicator lights 709a-b indicates the rapid-fire action or vibration mechanism 813 is activated. For charging wireless phone 100, charging circuitry 809 is coupled to electrical contacts (not shown) in the battery 811 and the external power circuit 815.

Battery meter 707 is also connected to battery 811 to indicate the amount of battery power in battery 811. The battery 811 is preferably, a removable, rechargeable battery, such as nickel-metal-hydride battery, a lithium ion battery, power cell or other similar energy storage device. Preferably the battery 811 is designed to be physically small and lightweight while storing substantial useable energy to provide a maximum operating time for the gaming shell structure 701 before requiring recharge. Further, the battery 811 is preferably designed to be located in a module or other housing which is detachably joined with the other elements of the gaming structure 701 in a single handheld unit to provide a radiotelephone handset or other device which maximizes user convenience.

Turning to the external power circuit 815, this power circuit interfaces with the external power port 710 to receive power from an external source or main power supply. The external power circuit 815 is equivalent to external power circuit 409 described above so a description of the operation of external power circuit 815 is omitted. External power circuit 815 is connected to processor 805 and motor driver 819.

Processor 805 transmits instructions to vibration mechanism 813 by utilizing motor driver 819. Also, processor 805 through charging circuitry 809 instructs the battery 811 or external power circuit 815 to supply power to the motor driver 819. Motor driver 819 receives the instruction and the power from battery 811 and/or external power circuit 815 to supply electrical energy to motor 817. Motor 817 is energized from the electrical power from motor driver 819. Vibration mechanism 813 is connected to status indicator lights 709a-b to indicate when the gaming shell structure 701 will vibrate. When the motor 817 is energized, then drive shafts in the motor 817 rotates to cause an eccentric member 813a in vibration mechanism 813 to rotate in an eccentric motion thereby generating vibrations. These generated vibrations are imparted to a left and right side portion of structure 701. Then the vibrations on the left and right side portion of structure 701 are applied to the hands of a user. In alternative embodiments, the vibration of vibration mechanism 813 will vary depending on the vibration instruction from the software program on wireless phone 100. For example, the rotational speed of the motor 817 varies based on a value of vibration included in a vibration instruction from wireless phone 100.

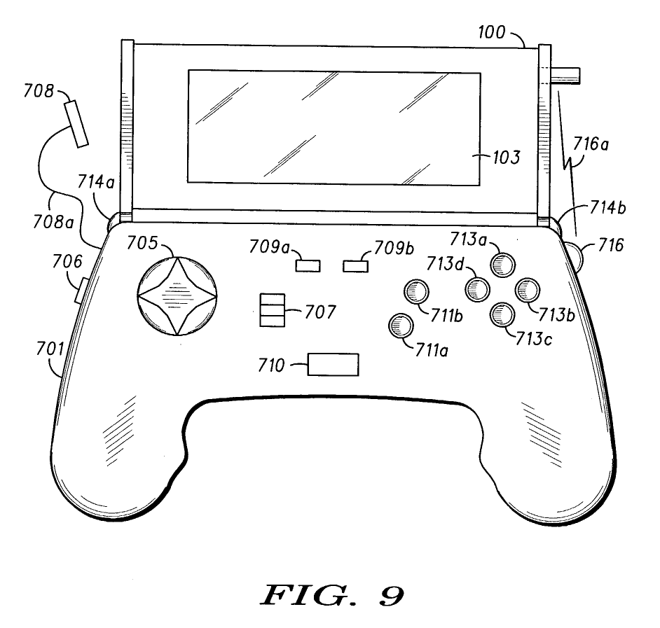

FIG. 9 is a schematic diagram showing the wireless phone 100 connected with the second embodiment of the gaming shell structure of FIG. 7. Structure 701 is shaped so that wireless phone 100 can be easily snapped into the structure by hinges 714a-714b. The hinges 714a-714b are easily adjustable and rotatable to fit any position desired by a user. The accessory port 708, connector 708a and accessory port 115 enables structure 701 to communicate with wireless phone 100. In addition, the accessory ports 708 and 115 allow at least one battery in wireless phone 100 to be charged by gaming shell structure 701. In an alternative embodiment, gaming shell structure 701 utilizes the hinges 714a-714b to receive any type of wireless phone or handheld wireless device.

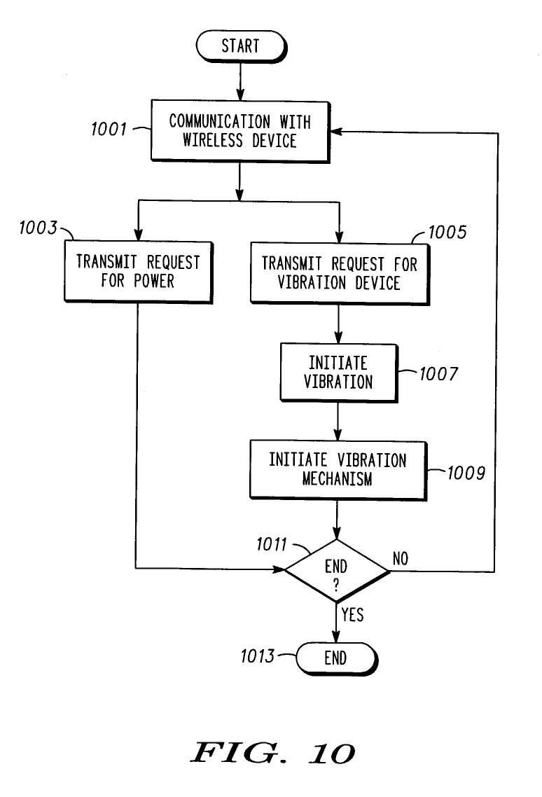

FIG. 10 is a flow chart that depicts the interaction between wireless phone and the first embodiment of the gaming shell structure 301 of FIG. 4. This flow chart provides an example of how the wireless phone 100 is charged and how the vibration mechanism 403 is initialized while simultaneously performing a gaming operation. By simultaneously performing a gaming operation at a wireless phone, while charging a battery at the phone a user is provided with the advantage of simply being able to play a game without worrying if the battery power is weakened.

Wireless phone 100 is inserted into the recess 302 of gaming shell structure 301. Accessory port 115 of wireless phone 100 is connected to accessory port 303 of gaming shell structure 301.

At block 1001, structure 301 is interfacing with wireless phone 100 by utilizing the accessory ports 303 and 115. This act of interfacing enables structure 301 to receive and transmit information to wireless phone 100. At block 1003, wireless phone 100 from controller 211 transmits a request for power from gaming shell structure 301 or instructions to initiate the vibration mechanism 403. When the accessory port 303 receives the requests for power, then accessory port 303 directly accesses charging circuitry 405 to receive power from battery 407 and/or external power circuit 409 while at least one user is simultaneously playing a game on the wireless phone 100. Charging circuitry 405 then transfers the power to the accessory port 303, which transfers the power to the wireless phone 100.

At block 1005, the accessory port 303 receives phone switched external power from accessory port 115. This switched power transmits electrical power from battery control 215, accessory port 115 through accessory port 303 to the motor 403b. At 1007, motor 403b is energized after receiving the electrical power, which causes the eccentric member 403a to move in a vibration motion causing the vibration mechanism 403 to vibrate at block 1009.

At block 1011, the recharging process ends and the vibration process ends. Depending on the instructions from the wireless phone 100, the recharging process and vibration process may be reinitiated at 1001 or end at 1013.

In an alternative embodiment of the gaming shell structure 301, the gaming shell structure 301 is able to receive instructions from the controller 211 in wireless phone 100 to simultaneously perform a gaming operation, vibrate the gaming shell structure 301 and charge the wireless phone 100.

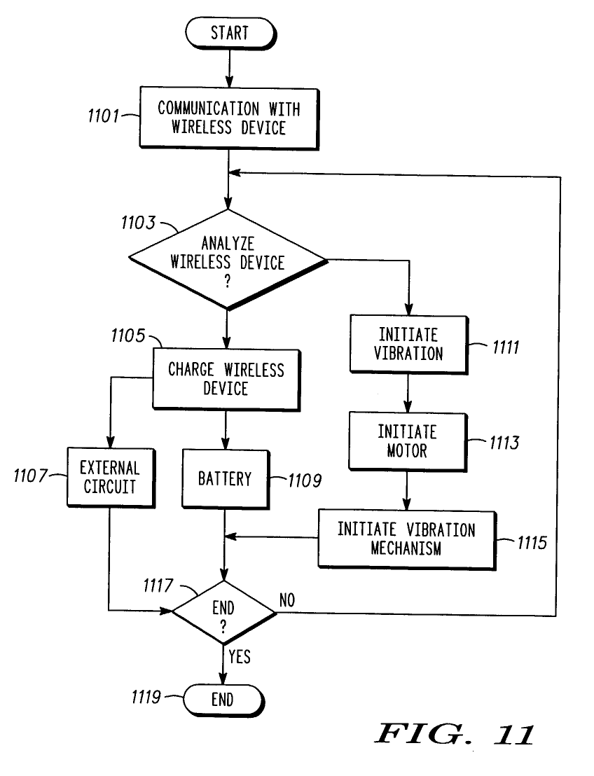

FIG. 11 is a flow chart that depicts the interaction between the wireless phone and the first embodiment of the gaming shell structure including the optional components of FIG. 5. This flow chart provides an example of how the wireless phone 100 is charged and how the vibration mechanism 403 is initialized while simultaneously performing a gaming operation. By simultaneously performing a gaming operation at a wireless phone, while charging a battery at the phone a user is provided with the advantage of simply being able to play a game without worrying if the battery power is weakened.

Wireless phone 100 is inserted into the recess 302 of gaming shell structure 301. Accessory port 115 of wireless phone 100 is connected to accessory port 303 of gaming shell structure 301.

At block 1101, structure 301 is interfacing with wireless phone 100 by utilizing the accessory ports 303 and 113. This act of interfacing enables structure 301 to receive and transmit information to wireless phone 100. At block 1103, structure 301, optional processor 505 and/or optional battery feedback line processor 507 utilizes the optional interface device 503 and accessory port 303 to receive information through the interface device from the processor in the wireless phone 100. After the processor 505 and feedback line processor 507 receives the information, then these components makes several possible assessments or determinations about the wireless phone 100.

For a first determination, the processor 505 and battery feedback line processor 507 may determine that the wireless phone 100 has requested electrical power from gaming shell structure 301 be sent to a battery in the wireless phone 100. In order to make this determination, processor 505 and/or battery feedback line 507 includes a detecting mechanism that detects the level of power in the battery of wireless phone 100. Next, processor 505 and/or battery feedback line 507 compares the level of power in the battery of the wireless phone 100 with a threshold level to determine if the wireless phone 100 needs power while at least one user is simultaneously playing at least one game on the wireless phone 100. For example, if the minimum level or threshold level of power needed to operate wireless phone 100 is in the range of 3-5 volts and processor 505 and/or battery feedback line 507 detects that the wireless phone 100 has power of less than 2 volts. Then optional processor 505 and/or battery feedback line processor 403 sends the power to wireless phone 100.

In an alternative embodiment, optional processor 505 can also receive a request from the processor in wireless phone 100 to supply power to a battery in wireless phone 100.

At block 1105, the optional processor 505 utilizes charging circuitry 405 and external power circuit 507 to recharge a battery in wireless phone 100. In an alternative embodiment, processor 505 may use external power circuit 409 to charge the battery of wireless phone 100. At block 1107, processor 505 instructs the external power circuit 409 to obtain power to charge the battery of the wireless phone. External power circuit 409 receives the electrical power from an external power supply (not shown). When the external power circuit 409 receives the electrical power from the external power supply, then it transmits it to the charging circuitry 405 and the processor to the battery of wireless phone 100. During the operation of gaming shell structure 301, processor 505 monitors the electrical power provided from the external source. When there is sufficient power for the structure 301, charging circuitry 405 allows current from the external source to flow to at least one battery in wireless phone 100 through interface device 503 and interface device 204 of wireless phone 100. Charging circuitry 405 may also allow current to flow from the external power circuit 409 to battery 407 to recharge it when necessary.

In yet another alternative embodiment, battery 407 supplies power to the wireless phone 100. At block 1109, battery 407 transmits electrical power through charging circuitry 405, processor 505 and interface device 503 through accessory port 303 to accessory port 115. Accessory port 115 transmits the electrical power through the interface device 204 to recharge the battery 217 in wireless phone 100.

In another determination, processor 505 determines that the processor in wireless phone 100 transmitted a vibration command to gaming structure 301 to initiate vibration mechanism 403 while a user is simultaneously performing a gaming operation on wireless phone 100. At block 1111, processor 505 receives a vibration command from wireless phone 100 to initiate vibration at vibration mechanism 403. In an alternative embodiment, this vibration command may be initiated at any time during any operation of wireless phone 100. For example, the vibration command may be transmitted from wireless phone 100 to structure 301 when a user is simultaneously playing a game on wireless phone 101.

At block 1113, processor 505 may use battery 407 or external power circuit 409 to charge the motor 403b that excites eccentric member 403a to cause vibration in vibration mechanism 403. If the external power supply is being utilized, then the external power supply supplies power through external power circuit 409 to the charging circuitry 405 to motor 403 to vibrate eccentric member 403 in vibration mechanism 403. If the battery 407 is being utilized, then it supplies power to motor 403b to vibrate the vibration mechanism 403.

In yet another alternative embodiment, a power supply in wireless phone 100 includes a switch B+ for transmitting electrical power from interface device 204 and accessory port 115 through accessory port 303, interface device 503, processor 505 to the motor 403b. Motor 403b is energized after receiving the electrical power, which causes the eccentric member 403a to move in a vibration motion causing the vibration mechanism 403 to vibrate.

In an alternative embodiment of the gaming shell structure 301, the gaming shell structure 301 is able to receive instructions from the controller 211 in wireless phone 100 to simultaneously perform a gaming operation, vibrate the gaming shell structure 301 and charge the wireless phone 100.

At block 1115, motor 403b is energized, then drive shafts in motor 403b rotates to cause an eccentric member 403a in vibration mechanism 403 to rotate in an eccentric motion thereby generating vibrations. These generated vibrations are imparted to a left and right side portion of structure 301. The vibrations on the left and right side portion of structure 301 are applied to the hands of a user. This vibration may last for a long or short period of time depending on the vibration command from wireless phone 100. In addition, the vibration of vibration mechanism 403 will vary depending on the vibration instruction from the controller 211. For example, the rotational speed of the motor 403b varies based on a value of vibration included in a vibration instruction from wireless phone 100.

At block 1117, the recharging process ends and the vibration process ends. Depending on the instructions from the controller 211 in wireless phone 100, processor 505 determines if this process should end at block 1119 or return to block 1103.

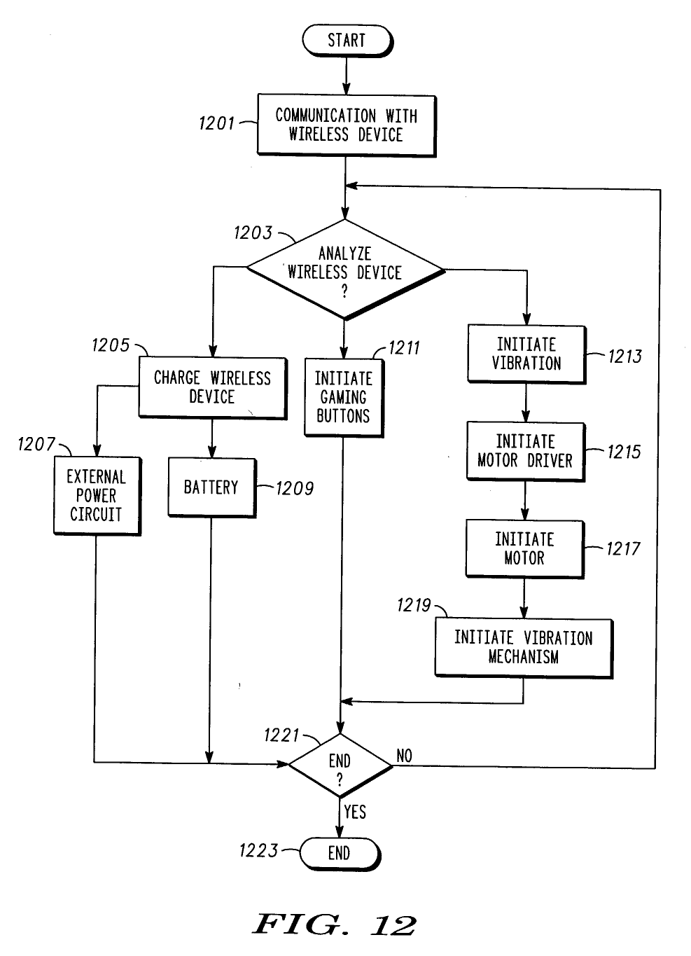

FIG. 12 is a flow chart that depicts the interaction between wireless phone and the second embodiment of the gaming shell structure of FIG. 7. This flow chart provides an example of how the wireless phone 100 is charged. In addition, this flow chart provides an example of how the switch 705, function buttons 711a-b, and gaming buttons 713a-d are utilized to performing gamine operation on wireless phone 100. Further, this example depicts the operation of vibration mechanism 813 in the gaming structure 701 when it receives a vibration command from the wireless phone 100 while a user is simultaneously performing a gaming operation on the wireless phone 100. By simultaneously allowing a user to perform a gaming operation which charging a wireless phone and initiating a vibration motion the user is easily able to enjoy playing a game for a prolong period of time without worrying about weakening the battery of the wireless phone.

Wireless phone 100 is connected to hinges 714a-714b of structure 701 as shown in FIG. 9. Accessory port 115 of wireless phone 100 is connected to accessory port 708 of structure 701.

At block 1201, structure 701 is interfacing with wireless phone 100 by utilizing the accessory ports 708 and 115. This act of interfacing enables structure 701 to receive and transmit information to wireless phone 100. At block 1203, structure 701, utilizes the processor 805 to analyze information from the wireless phone 100. Processor 805 utilizes the interface device 803 and accessory port 708 to receive information through the interface device 204 from the controller 211 in the wireless phone 100. For example, the processor in wireless phone 100 may request electrical power from structure 701 be sent to a battery in the wireless phone 100.

In another example, processor 805 receives instruction from the controller 211 in wireless phone 100 to utilize the switch 705, function buttons 711a-b and gaming buttons 713a-d. In yet another example, the processor in wireless phone may also transmit a vibration command to gaming shell structure 701 to initiate vibration mechanism 813. In yet another alternative embodiment, trigger switch 706 is connected to processor 805 and charging circuitry 809. When trigger switch is depressed the processor 805 and charging circuitry 809 instructs the battery and/or external power circuit 815 to supply power to wireless phone 100.

At block 1205, processor 805 receives the instructions from wireless phone 100 to charge the battery in the wireless phone 100. Processor 805 may also include a detecting mechanism that detects the level of power in the battery of wireless phone 100. Processor 805 may then compare the level of power in the battery of the mobile phone with a threshold level to determine if the wireless phone 100 needs additional power. For example, the minimum level or threshold level of power needed to operate wireless phone 100 is 4 volts and processor 805 detects that the wireless phone 100 has less than 4 volts, the processor 805 will instruct charging circuitry 809, battery 811 and/or external power circuit 815 to immediately begin recharging the wireless phone 100 until it reaches 4 volts. Processor 805 may use battery 319 or external power circuit 815 to charge the battery in wireless phone 100.

At block 1207, the external power supply is being utilized, then the external power supply supplies power through external power port 815 to the charging circuitry 809 and the processor 805 to the battery in the wireless phone 100. During the operation of structure 701, processor 805 monitors the electrical power provided from the external source. When there is sufficient power for the structure 701, charging circuitry 809 allows current from the external source to flow to at least one battery in wireless phone 100 through interface device 803 and interface device 204 of wireless phone 100. Charging circuitry 809 may also allow current to flow from the external power circuit 815 to battery 811 to recharge it when necessary.

At block 1209, processor 805 utilizes charging circuitry battery 319 to charge the battery of wireless phone 100. Battery 811 transmits electrical power through charging circuitry 809, processor 805 and interface device 803 through accessory port 708 to accessory port 115. Accessory port 115 transmits the power through the interface device 204 to recharge the battery 217 in wireless phone 100.

At block 1211, processor 805 receives instructions from wireless phone 100 and/or trigger switch 706 is depressed to initiate the utilization of the operating area 703. More specifically, the switch 705, function buttons 711a-b, gaming buttons 713a-d of operating area 703 are utilized. Processor 805 initializes utilization of the gaming key operating circuit 807. Gaming key operating circuit 805 detects the operating states containing data of the switch 705, function buttons 711a and gaming buttons 713a-d and transfers the data through processor 805, interface device 803 to wireless phone 100. At the wireless phone 100, the detected data is acted on in an operation of the wireless phone. For example, the switch 705 is utilized to move a character in a gaming operation of wireless phone 100. In another example, the gaming button 713a allows a character to punch while playing a game on wireless phone 100.

At block 1213, processor 805 receives instructions from wireless phone 100 to initiate a vibration command to vibration mechanism 813 and/or trigger switch 706 is depressed. This vibration command may be initiated at any time during any operation of wireless phone 100. For example, the vibration command may be transmitted from wireless phone 100 to structure 701 when a user is playing a gaming operation on mobile phone 101.

At block 1215, processor 805 transmits the instructions to motor driver 819 and charging circuitry 809. Charging circuitry 809 instructs the battery 811 or external power circuit 815 to supply power to the motor driver 819. At block 1217, motor driver 819 receives the instructions and the power from battery 811 and/or external power port 710 to supply electrical energy to motor 817.

At block 1219, motor 817 is energized, then drive shafts in motor 817 rotates to cause an eccentric member 813a in vibration mechanism 813 to rotate in an eccentric motion thereby generating vibrations. This vibration may last for a long or short period of time depending on the vibration command from wireless phone 100.

In an alternative embodiment of the gaming shell structure 701, the gaming shell structure 701 is able to receive instructions from the processor in wireless phone 100 to simultaneously perform a gaming operation, vibrate the gaming shell structure 701 and charge the wireless phone 100.

At block 1221, the recharging process ends and the vibration process ends. Depending on the instructions transmitted from the wireless phone 100 the processor 805 determines if this process should end at 1223 or return to 1203.

From the foregoing, it can be seen that the present invention provides an apparatus that allows a user to easily perform a gaming operation while playing a game on a wireless phone without weakening the battery in the phone.

The first and second embodiments of the gaming shell structures are configured to receive a wireless phone. These gaming shell structures allow a user to easily perform a gaming operation on the wireless phone while simultaneously charging the phone and implementing a vibration mechanism on the gaming shell structures. These structures also provide the advantage of allowing a user to simply play a game for a prolonged period of time without weakening the battery of the wireless phone.

While a particular embodiment of the present invention has been shown and described, modifications may be made. It is therefore intended in the appended claims to cover such changes and modifications, which follow in the true spirit and scope of the invention.

1. A method for playing at least one game on a handheld wireless device, the method comprising;
receiving instructions from the handheld wireless device at a communication device;
simultaneously performing a gaming operation on the handheld wireless device while determining at the communication device if the handheld wireless device should be supplied with power; and
supplying the power from the communication device to the handheld wireless device.

2. The method of claim 1 wherein said determining further comprises detecting a level of power in the handheld wireless device.

3. The method of claim 2 further comprises comparing the level of power with a threshold level in the communication device.

4. The method of claim 1 wherein the handheld wireless device comprises a wireless phone.

5. The method of claim 1 wherein the handheld wireless device comprises a personal digital assistant.

6. The method of claim 1 wherein the instruction comprises a request for the power.

7. The method of claim 1 wherein the communication device comprises a gaming shell structure.

8. A method for playing at least one game on a handheld wireless device, the method comprising;
receiving an instruction from the handheld wireless device at a communication device;
simultaneously performing a gaming operation on the handheld wireless device; and
initiating a vibration motion of the communication device.

9. The method of claim 8, wherein the instruction comprises a vibration command.

10. The method of claim 8 further comprises transmitting power from the handheld wireless device to the communication device to initiate the vibration motion.

11. The method of claim 8 further comprises generating power in the communication device to initiate the vibration motion.

12. A method for playing at least one game on a handheld wireless device, the method comprising;
receiving instructions from the handheld wireless device at a communication device;
simultaneously performing a gaming operation on the handheld wireless device;
determining at the communication device if an operating area of the communication device should be used in cooperation with the gaming operation of the handheld wireless device;
detecting operating states of the operating area; and
transmitting the operating states to the handheld wireless device to perform an action in the gaming operation.

13. The method of claim 12 wherein the operating area comprises, a cross-directional design switch, a plurality of function buttons, a plurality of gaming buttons, a battery meter and status indicator lights.

14. The method of claim 13 wherein determining further comprises detecting the operating state of the cross-directional design switch, the plurality of function buttons and the plurality of gaming buttons.

15. A system for performing at least one gaming operation on a handheld wireless device, the system comprising;
a communication device operative to receive an instruction from the handheld wireless device;
the communication device being operative to enable the handheld wireless device to simultaneously perform a gaming operation while the communication device is operative to determine if the handheld wireless device should be supplied with power; and
the communication device being operative to supply the power to the handheld wireless device.

16. A system for performing a gaming operation on a handheld wireless device, the system comprising;
the handheld wireless device is operative to transmit at least one instruction;
a communication device is operative to receive the at least one instruction;
the communication device is operative to simultaneously perform a gaming operation on the handheld wireless device while the communication device is operative to determine if an operating area on the communication device should be used in cooperation with the gaming operation; and
the communication device is operative to detect an operating state of the operating area; and
the communication device is operative to transmit the operating state to the handheld wireless device, responsive to the operating state the gaming operation is operative to perform an action.

17. A gaming shell structure, comprising:
an interface operative to receive an instruction;
a processor coupled to said interface, wherein said processor is operative to receive said instruction and simultaneously perform a gaming operation;
wherein the processor processes the information to determine if power should be supplied; and
a charging circuitry coupled to the processor, wherein the processor transmits instructions to supply power.

18. The gaming shell structure of claim 17 wherein the charging circuitry transmits the instructions to a battery, responsive to the instructions the battery supplies power to the charging circuitry.

19. The gaming shell structure of claim 17 wherein the charging circuitry transmits the instructions to an external power circuit, responsive to the instructions the external power circuit supplies power to the charging circuitry.

20. A gaming shell structure, comprising:
an interface operative to receive an instruction;
a processor coupled to said interface, wherein said processor is operative to receive said instruction and simultaneously perform a gaming operation, wherein the processor determines if a vibration command should be sent to a vibration mechanism;
the vibration mechanism coupled to the processor, wherein the vibration mechanism receives the vibration command; and
a charging circuitry coupled to the processor, wherein the processor transmits instructions to initiate the vibration command to the charging circuitry, wherein the charging circuitry transmits power to vibrate the vibration mechanism to the processor.

21. A method for playing at least one game on a handheld wireless device, the method comprising;
receiving an instruction from the handheld wireless device at a communication device, wherein the instruction is a request for power;
simultaneously performing a gaming operation on the handheld wireless device; and
supplying the power from the communication device to the handheld wireless device.

22. A system for performing at least one gaming operation on a handheld wireless device, the system comprising;
a communication device operative to receive an instruction from the handheld wireless device, wherein the instruction is a request for power; and
the communication device being operative to enable the handheld wireless device to simultaneously perform a gaming operation while the communication device is operative to supply the power to the handheld wireless device.

23. A gaming shell structure, comprising:
an accessory port operative to receive an instruction to supply power, wherein the accessory port is operative to simultaneously perform a gaming operation; and
a charging circuitry coupled to the accessory port, wherein the accessory port transmits instructions to supply power.

24. A gaming shell structure, comprising:
an accessory port operative to receive an instruction to initiate a vibration motion in a vibration mechanism, wherein the accessory port is operative to simultaneously perform a gaming operation; and
the vibration mechanism coupled to the accessory port, wherein the accessory port transmits instructions to initiate the vibration motion to the vibration mechanism.

25. A gaming shell structure, comprising:
an accessory port operative to receive instructions to supply power and initiate a vibration motion in a vibration mechanism, wherein the interface device is operative to simultaneously perform a gaming operation;
a charging circuitry coupled to the accessory port, wherein the accessory port transmits the instructions to supply power to the charging circuitry; and
the vibration mechanism coupled to the accessory port, wherein the accessory port transmits instructions to initiate the vibration motion to the vibration mechanism.

26. A gaming shell structure, comprising:
an accessory port operative to charge a wireless device, wherein the accessory port functions as a charger to the wireless device;
a vibration mechanism coupled to the accessory port, wherein the accessory port is operative to receive external power generated from the wireless device to initiate a vibration motion in the vibration mechanism; and
an outside area that encapsulates the vibration mechanism coupled to the accessory port, wherein this outside area is configured to easily access gaming control buttons on said wireless device that enhances ergonomics and playability of the wireless device.

27. A system for performing at least one gaming operation on a handheld wireless device, the system comprising;
a communication device operative to receive an instruction from the handheld wireless device, wherein the instruction comprises a vibration command; and
the communication device being operative to enable the handheld wireless device to simultaneously perform a gaming operation while the communication device being operative to perform a vibration motion.

28. A gaming shell structure, comprising:
a recess, wherein the recess is configured to receive a wireless device having an antenna, wherein the recess is configured to protect the antenna;
an accessory port being located in the recess being operative to charge the wireless device having the antenna, wherein the accessory port functions as a charger to the wireless device having the antenna;
a vibration mechanism coupled to the accessory port, wherein the accessory port is operative to receive external power generated from the wireless device having the antenna to initiate a vibration motion in the vibration mechanism; and
an outside area that encapsulates the vibration mechanism coupled to the accessory port, wherein this outside area is configured to easily access gaming control buttons on said wireless device that enhances ergonomics and playability of the wireless device having the antenna.

29. A gaming shell structure, comprising:
an accessory port operative to charge a wireless device having a first antenna, wherein the accessory port functions as a charger to the wireless device having the first antenna;
a vibration mechanism coupled to the accessory port, wherein the accessory port is operative to receive external power generated from the wireless device having the first antenna to initiate a vibration motion in the vibration mechanism;
an outside area that encapsulates the vibration mechanism coupled to the accessory port, wherein this outside area is configured to easily access gaming control buttons on said wireless device having the first antenna that enhances ergonomics and playability of the wireless device having the first antenna; and
a second antenna coupled to the outside area, wherein the second antenna is coupled to the wireless device to improve the performance of the wireless device having the first antenna.
